(19) United States
(12) Patent Application Publication
(10) Pub. No.: US 2003/0128129 A1
(43) Pub. Date: Jul. 10, 2003

(54) Operator controller with combination of alert and message, operator provided therewith and method for operating same

(76) Inventor: Axel Stab, Berlin (DE)

Correspondence Address: STEVENS, DAVIS, MILLER & MOSHER, LLP, Suite 850, 1615 L Street N.W., Washington, DC, 20036, US

(21) Appl. No.: 10/319,819

(22) Filed: Dec. 16, 2002

(30) Foreign Application Priority Data
Nov. 20, 2002 (EP) 02026311.7
Dec. 20, 2001 (DE) 20120655.2

(51) Int. Cl. G08B 21/00

(52) U.S. Cl. 340/686.1; 340/5.71

(57) ABSTRACT

The invention relates to an operator controller for controlling an operator for a powered closure of a building or enclosure, more particularly a door operator controller, including an apparatus for informing a user as to the operating status of the operator controller and/or of the operator to be controlled or of the closure to be powered, especially as to a status requiring user intervention. To avoid unnecessary service calls it is proposed that the operating status information apparatus comprises an apparatus for outputting a combination of a warning signal and message clearly indicating the operating status, preferably without the assistance of any further information. The invention also relates to an operator provided therewith as well as to a method of operating same.

This claims priority under 35 USC Section 119 of German Utility Application 201 20 655.2 of Dec. 20, 2001, and European Patent Application 02 026 311.7 of Nov. 20, 2002, both of which are incorporated herein by reference in their entirety.

### FIELD OF THE INVENTION

The invention relates to an operator controller of the kind for controlling an operator for a powered closure of a building or enclosure, as for example known from German utility model DE 200 10 314 U1, incorporated herein by reference in its entirety, as well as to an operator provided therewith. In addition, the invention relates to a method of operating such an operator and controller respectively.

### PRIOR ART

It is generally the situation with current (garage door) operators that when at fault or an unusual situation (i.e. unexpected by the user) occurs, it is only the operator that reacts according to the circumstances whilst leaving the user in the dark as to why it has reacted thus.

Although many operators include a visual alert indicating the cause of the trouble, this display is discrete and usually coded by displaying a train of digits or a flashing lamp sequence which is of no immediate help to the user in such a nuisance situation since it usually requires him to look up the cause in the Operating Manual of the device.

One example in the field of garage door operators is a light beam sensor in the doorway which, as soon as the light beam is interrupted, a) halts an already commenced door closing action and then instantly reversing the operator to UP or b) prevents door closing (door remains open despite being instructed to close, i.e. wanted door closing action is not even commenced).

The cause for b) for instance, could be simply that the user has placed his bag accidental blocking the light beam.

The user fails to understand the reaction of the operator (door will not close) and thus he assumes the operator is defective. This prompts him to call in the service people to correct the defect. Instead, the operator has reacted quite correctly and could be reinstated quite simply (in this case by removing the bag).

Saving such unnecessary service calls is in the interest of both the user and the maker/dealer/fitter of the system. This is why the following describes a method and means for practically eliminating such situations.

### SUMMARY OF THE INVENTION

It is thus the objective of the invention to configure or operate an operator controller of the kind for controlling an operator for a powered closure of a building or enclosure, including a means for informing a user as to the operating status of said operator controller and/or of said operator to be controlled or of said closure to be powered so that such unnecessary service calls can now be avoided.

This objective is achieved by an operator controller, an operator and an operating method.

The solution approach as described in the following is based on the user now being clearly informed as to the unexpected or wanted reaction of the operator whilst disclosing the cause and indicating, where necessary, what is to be done.

This may be achieved by a combination of visual messages (some of which may already exist) and audio messages as regards the operator and its controller.

### BRIEF DESCRIPTION OF THE DRAWINGS

Example embodiments of the invention will now be detailed with reference to the attached drawing in which:

FIG. 1 is a diagrammatic illustration of a door operator, and

FIGS. 2a, 2b, 2c, 2d are each a part of a flow chart illustrating the sequence of events in operation of a door operator as shown in FIG. 1.

### DETAILED DESCRIPTION OF PREFERRED EMBODIMENTS

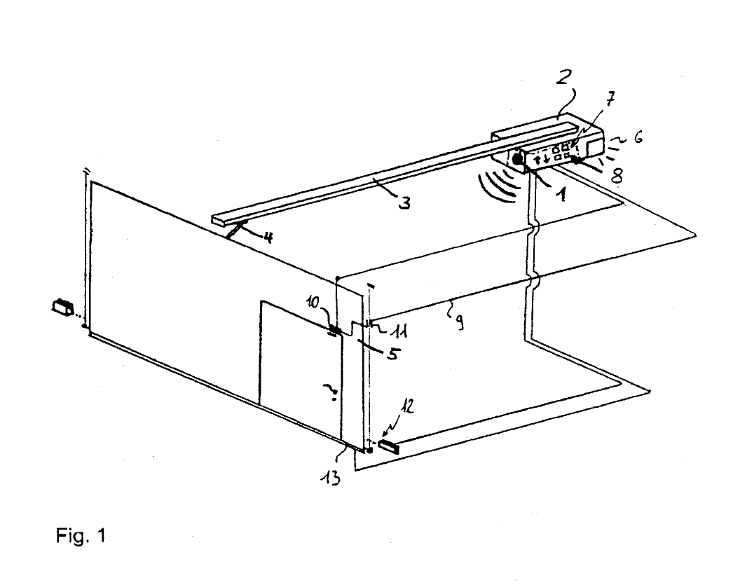

Referring now to FIG. 1 there is illustrated a door operator comprising a motor housing 2, a loudspeaker 1 and a transmission 3 in the form of a guide rail mounting a carriage 4. The door operator powers a door panel identified by reference numeral 5. The door operator includes further a lamp unit 6, a display device 7 displaying in this case pictograms (diagrammatically shown by squares and arrows) and a door operator controller 8 accommodated in the housing 2. The controller 8 comprises a microcontroller (not shown) in which the individual control units are achieved by means of software circuits. The door operator controller is identified by reference numeral 8 and indicated by a dot-dashed line. Connected to the controller 8 is a halt circuit 9 including an escape door switch 10 and a pull-cord switch 11. Connected furthermore to the controller 8 is a light beam sensor 12 and an closing edge sensor 13.

The door operator as shown is devised by means of its controller 8 to alert a user clearly to an unexpected accidental reaction of the operator whilst disclosing the cause thereof and, where necessary, indicating the solution to the problem.

This is done preferably by a combination of audiovisual messages.

For this purpose, as shown in FIG. 1, an audio response is provided via the loudspeaker 1.

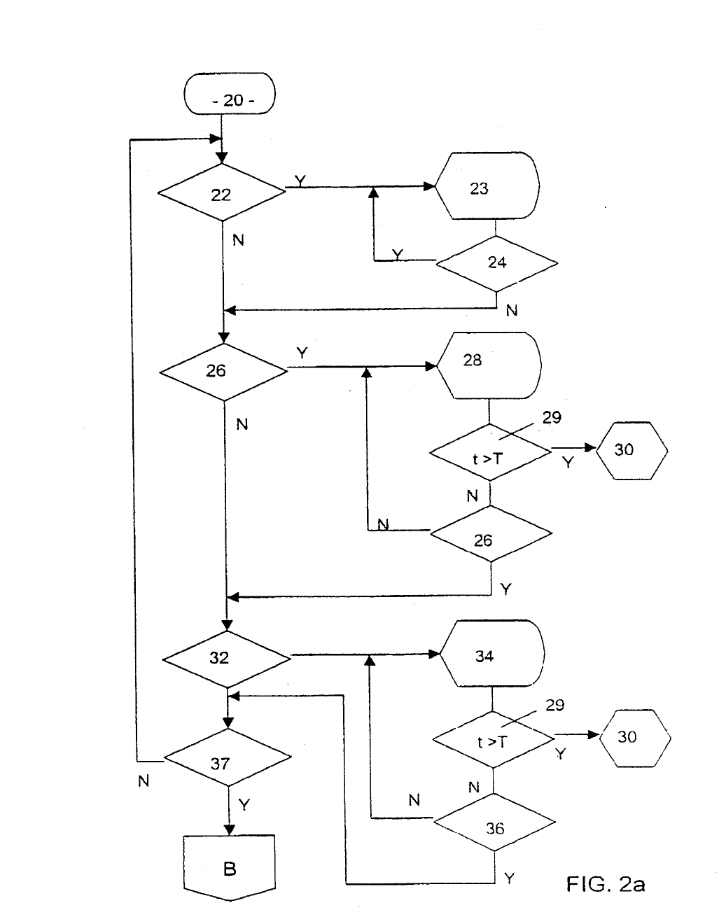

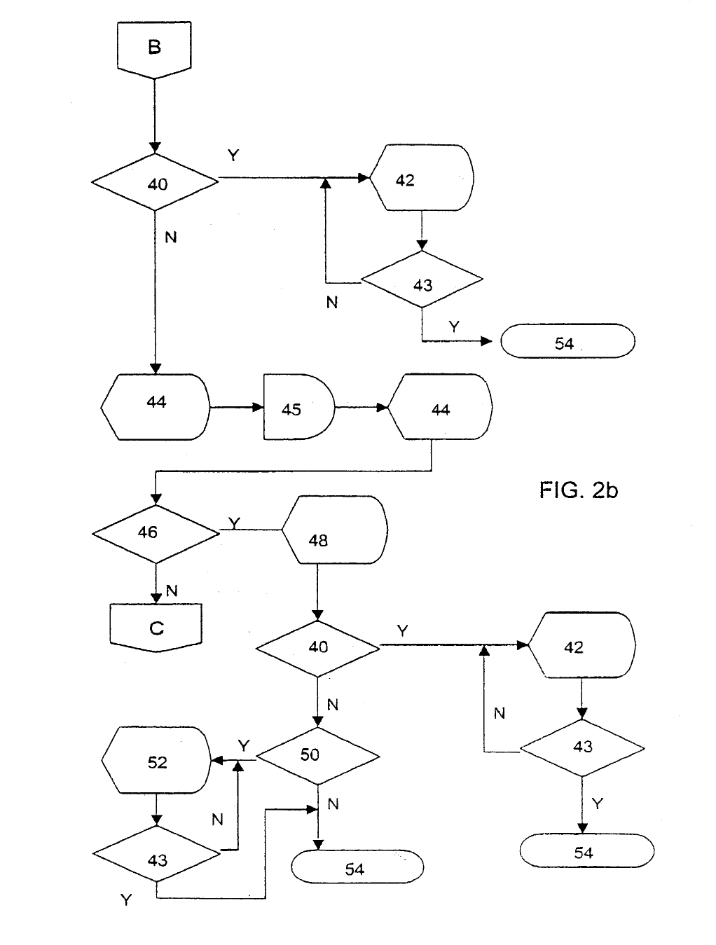

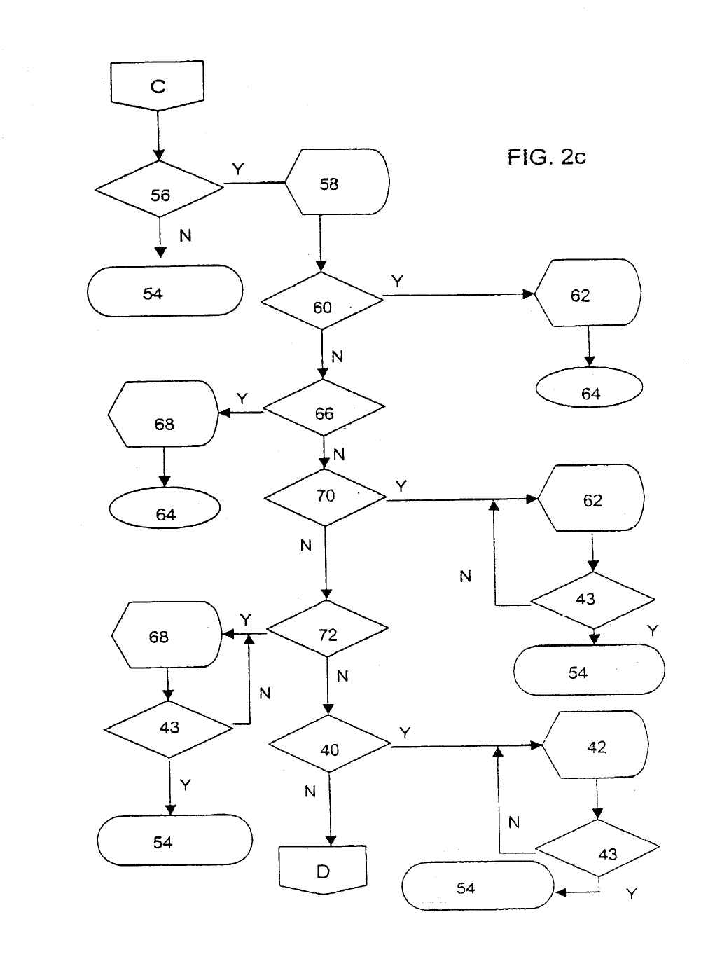

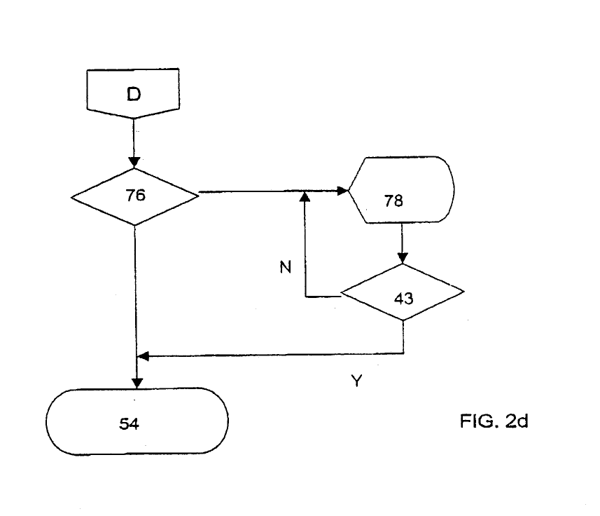

A method of operating the audio response unit is evident from the flow chart as shown in FIGS. 2a-2d, which is self-explanatory on the basis of the following legends:

20 start;

22 operator needs teaching?,

23 audio response: “Teach me!”;

24 operator still dumb after wait?;

26 is operator referenced?;

28 audio response: “Open up fully!”;

29 Is timeout (a few hours) exceeded?;

30 output “OFF” and stop:

32 serious operator fault?

34 audio response: “Call service!”;

36 fault remedied?;

37 action instruction?;

40 halt circuit interrupted?;

42 audio response: “halt circuit open because of escape door or pull-cord switch!”;

43 message receipt after wait?;

44 audio response: “Caution door closing!”;

45 prewarning of 2 or 5 secs;

46 door to be opened?;

48 audio response: “Caution door opening!”;

50 force limit “open” violated?;

52 audio response: “obstacle to opening!”;

54 stop or back to start;

56 door to be closed?;

58 audio response: “Caution, door closing!”;

60 no closing due to edge sensor alert?;

62 audio response: “edge sensor alert!”;

64 back to start;

66 no closing due to light beam sensor?;

68 audio response: “light beam sensor alert”;

70 door reverse UP due to edge sensor alert?;

72 door reverse due to light beam sensor?;

76 door reverse UP due to force limit violation”?;

78 audio response: “obstacle to closing!”.

Special Messages by Audio Response and Coded Display (See DE 200 10 314 U1 to Which Express Reference is Made as Regards Further Details, Particularly as Regards Configuration and Function)

Scenario: The (garage door) operator includes a loudspeaker 1, or it can be connected thereto, for outputting short texts in the spoken language of the country concerned pertinent to the various situations as prompted by the operator controller 8. In addition, a visual alert as a combination of digits, flashing lamp sequences, etc is displayed coded.

The audio response can be programmed (as to language of the country concerned, volume down to completely OFF, only for alerts as to unexpected reactions, etc) and could involve the following (not conclusive) listed in Table 1:

TABLE 1

| | Possible | |
|---|---|---|
| situation/ | spoken | |
| reaction | text | remarks |
| Door UP | Caution | expected reaction; optional either only on |
| (normal) | door | commencement or continually during door |
| | opening! | movement |
| Door DOWN | Caution | expected reaction; optional either only on |
| (normal) | door | commencement or continually during door |
| | closing! | movement |
| Reverse UP due to | Obstacle to | unexpected reaction; on commencement |
| force limit violation | closing! | of reverse movement and then e.g. with wait |
| DOWN | | periods until cancelled |
| Stop due to force | Obstacle to | expected reaction; on stop and then e.g. |
| limit violation UP | opening! | with wait periods until cancelled |
| Reverse UP due to | closing | unexpected reaction; on commencement |
| closing edge sensor | edge | of reverse movement and then e.g. with wait |
| alert | sensor | periods until cancelled |
| | alert! | |
| No closing due to | closing | unexpected reaction; every time closing |
| closing edge sensor | edge | cannot be started |
| alert | sensor | |
| | alert! | |
| Reverse action due | light beam | unexpected reaction; on commencement |
| to light beam sensor | sensor | of reverse action and then e.g. with wait |
| | alert! | periods until cancelled |
| No closing due to | light beam | unexpected reaction; every time closing |
| light beam sensor | sensor | cannot be started |
| | alert! | |
| Stop due to interrupt | halt circuit | unexpected reaction; every time a |
| of halt circuit (due to | interrupt due to | door action cannot be started and |
| escape door contact | escape door | when this prompts a stop and then e.g. |
| or pull cord switch) | contact or pull | with wait periods until cancelled |
| | cord switch | |
| During door open | Caution, door | expected reaction; e.g. count-down |
| time | closes | output |
| | automatically in x | |
| | seconds | |
| During prewarning | Caution, door | expected reaction; on |
| time | action! | commencement and shortly before end |
| | or just: caution! | of prewarn time (which is only 2 or 5 |
| | | secs long) |
| Operator needs | Teach me! | unexpected reaction; e.g. message is |
| teaching | | repeated with wait periods until |
| | | teaching accomplished |
| Serious operator | Call in service! | unexpected reaction; e.g message is |
| fault | | repeated with wait periods and |
| | | operator “OFF” after a few hours |
| Operator has no | Open up fully! | unexpected reaction; e.g. message is |
| references; e.g. | | repeated with wait periods and |
| following power | | operator “OFF” after a few hours. |
| failure | | |

Special Messages by an Audio Signal with the Possible Addition of a Coded Display

Whilst the solution as described in [0019] is fully comprehensive it is sometimes sufficient to simply “accompany” certain unexpected reactions often occuring from experience.

The following relates to the example with the light beam sensor 12 as cited in [0005].

Scenario: The (garage door) operator includes an audible signal device 1, or it can be connected thereto, by means of which audio signals can be put out when the light beam of the sensor 12 is interrupted, an already commenced door closing action is halted and the operator then immediately caused to reverse up to the door UP position or closing is prevented (door remains open despite action instruction, the wanted closing action being ignored.

These audio signals are put out only when the operator has an unexpected reaction; “normal” passing the light beam sensor 12 when the door is e.g. open or in opening action is not “commented”.

These audio signals may continue until cancelled or cease on count out; optionally it may be completely disabled.

Since these audio signals are associated only with the light beam sensor 12, the user is clearly aware that the unexpected reaction is because of the light beam sensor 12 and he is thus able to localize and remedy the situation by e.g. simply removing the bag as mentioned in [0006].

An additional coded digit or flashing lamp sequence display 7 (lamp 6) could be provided independently of the above.

Special Visual Alerts with the Possible Addition of a Coded Display

One variation of the solution as described in [0021] is to either replace or supplement the audible signal device(s) by an additional or already installed visual component such as e.g. operator lamp 6 to “accompany” unexpected reactions of the operator.

Thus the audible signals as described in [0021] may be supplemented or replaced by e.g. flashing signals of the operator lamp 6 which may also be rendered adjustable the same as the audible signals.

Since flashing is associated only with the light beam sensor 12, the user is clearly aware that the unexpected reaction is because of the light beam sensor 12 and is thus able to localize and remedy the situation by e.g. simply removing the bag as mentioned in [0006].

An additional coded digit or flashing lamp sequence display could be provided independently of the above.

Special Messages by Audible or Visible Signals with Clear Text Display

As an alternative to the audio response in [0019] it is likewise conceivable to replace a coded digit or flashing lamp sequence display by a clear text display. The audio response as indicated in [0019] then being displayed as clear text.

To alert the user to this display in an unexpected reaction an audio or visual alerting as described in [0021] or [0028] e.g. by flashing of the operator lamp 6 is additionally provided.

Special Messages by a Combination of Signals and Clear Text Output

It is, of course, just as possible to employ audio response, spoken text, voiced alert, clear text display, audio signals or/and visual signals in any special combination in accordance with any particular application.

The important thing in this case is simply that the user is clearly alerted to the cause of the unexpected reaction in giving him the opportunity to react accordingly.

Concrete Embodiment

A further concrete embodiment of the invention materializes from supplementing the operator controller as described in DE 200 10 314 U1 by means for combining a warning signal, for instance a flashing signal at the door operator controller 8, an additional audio signal or an additional (unusual) visual signal such as (unusual) flashing of the usual door operator lamp 6 with a spoken message which is easy to understand.

The message informing the user as to operating status and/or the remedying steps needed could also be e.g. a pictogram which is illuminated or produced on a display matrix.

What is claimed is:

1. An operator controller for controlling an operator for a powered closure of a building or enclosure, including a means for informing a user as to the operating status of said operator controller and/or of said operator to be controlled or of said closure to be powered, wherein said operating status information means comprises means for outputting a combination of a warning signal and a message, which indicates clearly said operating status.

2. The operator controller as set forth in claim 1, wherein said warning signal comprises an audio and/or visual signal.

3. The operator controller as set forth in claim 2, wherein said visual signal comprises flashing of a lamp provided on said operator.

4. The operator controller as set forth in claim 1, wherein said message is or comprises at least one member of the group consisting of a voiced message, a clear text display and display of a pictogram.

5. An operator for a powered closure of a building or enclosure, comprising an operator controller as set forth in claim 1.

6. A method of operating an operator as set forth in claim 5, comprising:
displaying an operating status of said operator necessitating user intervention by a warning signal and a message clearly indicating said operating status without the assistance of any further information.

7. The method as set forth in claim 6, wherein said operating status is indicated by a voiced message and/or a clear text display.

8. The method as set forth in claim 6, wherein said warning signal is output by a voiced alert and/or by an audio signal.

9. The method as set forth in claim 6, wherein an unexpected reaction of said operator is explained by said voiced message and/or clear text display.

10. The method as set forth in claim 6, wherein an expected reaction is announced by said voiced message.

11. The method as set forth in claim 6, wherein at least one of the following operating states is indicated by a voiced message and/or clear text display;
Door opening;
Door closing;
Door reversal or stop due to
force limit violation,
edge sensor activated,
light beam sensor activated or
interrupted halt circuit;
No door start due to
edge sensor activated,
light beam sensor activated or
interrupted halt circuit
AUTO door start in a few seconds;
Operator needs learning;
No reference values due to power failure and/or
Serious operator fault.

12. The operator controller of claim 1, wherein
the operator for the powered closure of the building or enclosure, comprises a door operator controller, and the means for informing the user as to the operating status of said operator controller and/or of said operator to be controlled or of said closure to be powered comprises a means for informing the user as to a status requiring user intervention, wherein said means for outputting said combination of said warning signal and said message comprises means for outputting said combination of said warning signal and said message which indicates clearly, without the assistance of any further information, said operating status.

13. The operator controller as set forth in claim 1 wherein said warning signal is selected from the group consisting of a voiced alert, beeping, hooting and/or a sequence of several warning sounds.

14. An operator for a powered closure of a garage door of a building or enclosure, comprising an operator controller as set forth in claim 1.

15. An operator for a powered closure of a building or enclosure, comprising an operator controller as set forth in claim 2.

16. An operator for a powered closure of a building or enclosure, comprising an operator controller as set forth in claim 3.

17. An operator for a powered closure of a building or enclosure, comprising an operator controller as set forth in claim 4.

18. The method as set forth in claim 6, wherein said warning signal comprises an audio and/or visual signal.

19. The method as set forth in claim 6, wherein said visual signal comprises flashing of a lamp provided on said operator.

20. The method as set forth in claim 6, wherein said message is or comprises at least one member of the group consisting of a voiced message, a clear text display and display of a pictogram.
